(19) United States
(12) Patent Application Publication
(10) Pub. No.: US 2026/0154133 A1
(43) Pub. Date: Jun. 4, 2026

(54) METHODS AND SYSTEMS FOR STREAM-PROCESSING IN A DISTRIBUTED EVENT DATA STORE

(71) Applicant: The Toronto-Dominion Bank, Toronto (CA)

(72) Inventors: Jason Kim Kang Trang, Ottawa (CA); William Jonathan James McArthur, Toronto (CA); George Elias Ibrahim Gouel, Montreal (CA); Victor Mao, Markham (CA); Thomas Bianchi, Toronto (CA); Ranjith Jeyabalan, Pickering (CA); Parveen Kumar, Gurugram (IN)

(21) Appl. No.: 18/965,608

(22) Filed: Dec. 2, 2024

(51) Int. Cl. G06F 9/54; G06F 16/2455

(52) U.S. Cl. CPC G06F 9/542; G06F 16/2455

(57) ABSTRACT

Methods and systems for stream processing in a distributed event data store system. The systems comprise a stream processor system configured to: consume, in real-time, a stream of events stored in a topic by a set of one or more event streaming routers; stream the consumed events to the set of one or more event streaming routers for storage in a compacted topic; update data in a local store of the stream processor system based on the events in the compacted topic; periodically query the local store to determine if one or more conditions is met; and in response to determining that at least one condition of the one or more conditions is met, take an action.

### TECHNICAL FIELD

The disclosed example embodiments relate to computer-implemented methods and systems for stream processing in a distributed event data store, and more particularly to computer-implemented methods and systems for processing a stream of events in real time and processing those same events at a later time.

### BACKGROUND

Both event-driven architectures (EDAs) and event streaming services use the concept of “events” to trigger and communicate between services which can allow systems to detect, process, manage and react to real-time events as they happen. An event records the fact that “something happened” in a system, and can refer to an action, incident or change that is identified or recorded by software or applications. An event generally comprises a key that identifies the event or the entity it pertains to and a value that holds the actual data. An event may also include other information such as, but not limited to, a timestamp that indicates when the event occurred and/or metadata about the event source etc.

EDAs and event streaming systems comprise producers, consumers, and routers. Producers, which may also be referred to as publishers, are nodes that generate events. Consumers, which may also be referred to as subscribers, are nodes that read and process events. Routers, which may also be referred to as brokers, are nodes that act as intermediaries between producers and consumers. Specifically, routers receive events from producers and provide events to consumers. Having routers between producers and consumers means that the producers and consumers do not have to communicate directly with each other, allowing them to be independent.

Where EDAs publish a single-purpose event that another application or service can use, event-streaming services, such as Apache™ Kafka™, publish streams of events to a router. Consumers in event streaming platforms can access each stream and consume their preferred events. A stream of events is a constant flow of events. Streamed events are processed in real-time as they are delivered to a system. EDAs and event streaming services can be used separately or in conjunction.

In event streaming platforms events may be organized and stored in topics. A topic is akin to a folder in a filesystem and the events are akin to files in that folder. Topics keep events in the same order as they occur in time (i.e., topics store a sequence of events). Accordingly, each new event is added to the end of the sequence. Once an event has been added to a topic, it cannot be modified (i.e., it is immutable). A topic may be multi-producer and/or multi-consumer. A set of consumers that reads from a topic is referred to as a consumer group.

Events in a topic may be stored for a predetermined duration. Topics can thus be distinguished from queues because, in contrast to a queue, once an event is consumed from a topic, it may stay in the topic until the predetermined duration has expired.

Each event published to a topic is delivered to a consumer that has subscribed to that topic. A consumer can read data from any offset within a topic. In most cases, a consumer advances its offset linearly, but it could start at any offset and read messages in any order. The consumer will typically “commit” its offset back to the routers so that the consumer can resume from where it left off, for example, in case it restarts.

### SUMMARY

The following summary is intended to introduce the reader to various aspects of the detailed description, but not to define or delimit any invention.

A first aspect provides a distributed event data store system comprising: a stream processor system comprising a memory, a communication interface and at least one processor operatively coupled to the memory and the communication interface, the stream processor system configured to: consume, in real-time, a stream of events stored in a topic by a set of one or more event streaming routers; stream the consumed events to the set of one or more event streaming routers for storage in a compacted topic; update data in a local store of the stream processor system based on the events in the compacted topic; periodically query the local store to determine if one or more conditions are met; and in response to determining that at least one of the one or more conditions is met, take an action.

Taking an action may comprise generating a new event and providing the new event to the set of one or more event streaming routers for storage in the topic or a different topic.

The new event may be a notification event, and the distributed event data store system may further comprise a notification system configured to consume the notification event.

The notification system may be configured to, in response to consuming the notification event, send a notification to an end-user.

The stream processor system may comprise a punctuator and the punctuator may be configured to periodically query the local store to determine if the one or more conditions is met.

The stream processor system may comprise an event processor and the event processor may be configured to consume the stream of events in the topic and stream the consumed events to the set of one or more event streaming routers for storage in the compacted topic.

The local store may be a state store.

Each event of the stream of events stored in the topic may comprise a key that identifies an entity that the event pertains to, and updating the data in the local store of the stream processor system based on the events in the compacted topic may comprise maintaining, in the local store, a record for each unique key that identifies a state of the corresponding entity.

An event of the stream of events stored in the topic may have an end date associated therewith and a condition of the one or more conditions may be met if a current date is a predetermined period from the end date associated with the event.

The stream processor system may be further configured to, in response to determining that at least one of the one or more conditions is met, remove data from the local store associated with the at least one condition.

The stream processor system may be further configured to periodically prune data in the local store based on one or more pruning conditions.

The system may further comprise the set of one or more event streaming routers configured to: receive the stream of events from an event producer and store the received events in the topic; and receive the consumed events and store the consumed events in the compacted topic.

A second aspect provides a method of stream processing, the method executed in a computing environment comprising a stream processor system comprising at least one processor, a communication interface, and memory, and the method comprising: consuming, in real-time, a stream of events stored in a topic by a set of one or more event streaming routers; streaming the consumed events to the set of one or more event streaming routers for storage in a compacted topic; updating data in a local store of the stream processor system based on the events in the compacted topic; periodically querying the local store to determine if one or more conditions is met; and in response to determining that at least one condition of the one or more conditions is met, taking an action.

Taking an action may comprise generating a new event and providing the new event to the set of one or more event streaming routers for storage in the topic or a different topic.

The local store may be a state store.

Each event of the stream of events stored in the topic may comprise a key that identifies an entity that the event pertains to, and updating the data in the local store of the stream processor system based on the events in the compacted topic may comprise maintaining in the local store a record for each unique key that identifies a state of the corresponding entity.

An event of the stream of events stored in the topic may have an end date associated therewith and a condition of the one or more conditions may be met if a current date is a predetermined period from the end date associated with the event.

The method may further comprise, in response to determining that at least one of the one or more conditions is met, removing data from the local store associated with the at least one condition.

The method may further comprise, periodically pruning data in the local store based on one or more pruning conditions.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a block diagram of an example system for stream processing;

FIG. 2 is a sequence diagram that illustrates an example set of interactions between the components of the system of FIG. 1 to process an example set of events;

FIG. 3 is a flow diagram of an example method for stream processing; and

FIG. 4 is a block diagram of an example computer which may be used to implement all or a portion of the system of FIG. 1 and/or execute all or a portion of the method of FIG. 3.

### DETAILED DESCRIPTION

In some cases, it may be desirable to be able to consume a set of events in real-time and process those same events at a later time. In other words, it may be desirable to react to previous real-time events at a later time. One solution to this is to create a database, such as an SQL (structured query language) database, and persist those events (i.e., the events that you also want to process at a later time) in the database. However, if a database isn't already available, setting up a new database adds additional infrastructure, cost, and ongoing maintenance.

Accordingly, described herein are systems and methods for leveraging event streaming platforms, such as, but not limited to, Apache™ Kafka™, to consume events in real-time and process those same events at a later time without requiring a separate database. In some cases, the events may be used to trigger or schedule new events.

In event streaming platforms, such as, but not limited to, Apache™ Kafka ™, a real-time stream of events is stored in a topic and once an event in a topic has been consumed in real-time by a consumer it is effectively no longer available to that consumer. However, as noted above, there are cases where it would be beneficial to be able to process events in real-time and process the same events at a later time. For example, a client of a bank may book a particular interest rate for a mortgage that will be valid for a certain period of time (e.g., 120 days). If the client has not yet funded their mortgage, the bank may want to send a reminder to the client 10 days before the expiry date of the interest rate. If the bank system generates a rate booked event when the rate is booked, the rate booked event may be stored in a related topic (e.g., a rate topic). The rate booked event may then be consumed by a consumer in real time to record and otherwise process the rate booking, which means the event cannot be used later by the consumer to trigger a reminder.

The systems and methods described herein address this issue by leveraging features of event streaming platforms, and, specifically their ability for an event processor to store events locally and query the stored events, to be able to process an event in real-time and process the event at a later time to, for example, trigger or schedule a new event. Specifically, in the systems and methods described herein, events in a stream are stored in a topic, the events in the topic are consumed by a stream processor system that streams the events to a different, compacted topic, and stores the events in a local store. The events in the local store are queried on a periodic basis to identify one or more conditions, and in response to identifying one of the one or more conditions, an action can be taken (e.g., a new event can be created). In other words, by persisting events in a local store backed by a compacted topic the events can be later processed.

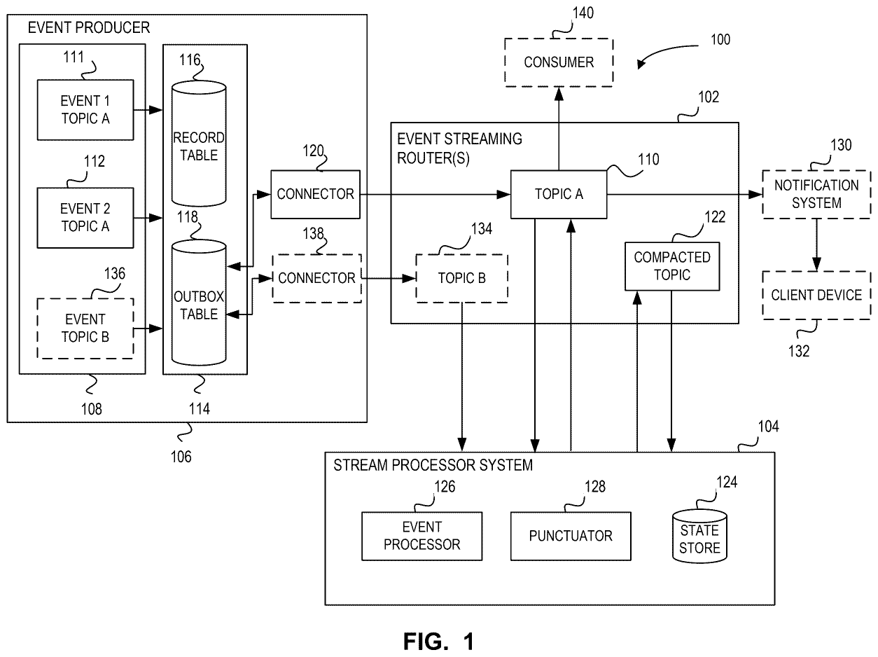

Reference is now made to FIG. 1 which illustrates an example system 100 for stream processing wherein the same events can be processed in real-time and at a later time. The system 100 comprises a set of one or more event streaming routers 102 and a stream processor system 104 operatively and/or communicably coupled to the set of one or more event streaming routers 102.

As described above, an event streaming router is a computing system or node that acts as an intermediary between event producers, which are nodes that generate events, and event consumers, which are nodes that consume events. Specifically, event streaming routers receive and store events from producers and provide the received events to consumers. The event streaming routers can thus be described as implementing an event data store. Having event streaming routers between event producers and event consumers means that the producers and consumers do not have to communicate directly with each other, allowing the producers and consumers to be independent. The set of one or more event streaming routers 102 may, in some cases, be implemented as a distributed system comprising one or more servers which may be located in multiple datacenters or cloud regions.

The set of one or more event streaming routers 102 of FIG. 1 is configured to receive a stream of events produced by one or more event producers 106 in real-time and store the received events in an associated topic (e.g., “Topic A” 110) for consumption by one or more consumers. For example, the one or more event producers 106 may generate mortgage rate events which the set of one or more event streaming routers 102 may store in a “Rate” topic.

As described above, a topic is akin to a folder in a filesystem and the events are akin to files in that folder. Generally, topics keep events in the same order as they occur in time (i.e., topics store a sequence of events). So, each new event is added to the end of the sequence. Generally, once an event has been added to a topic, it cannot be modified (i.e., it is immutable).

In some cases, as shown in FIG. 1, the event producer 106 may leverage Output Transactional Pattern to produce events. Output Transactional Pattern is designed to address issues that can arise where an event (e.g., transaction) is to trigger both a database update and the publishing of an event to an event streaming platform. Specifically, problems can occur if, when an event (e.g., a transaction) occurs, a database is updated to reflect the message, and subsequently an event related to the message is published to an event streaming platform. Specifically, if there are issues encountered in publishing the event to the event streaming platform, this may result in the system that processes the events being out of sync with the database. Output Transactional Pattern addresses this issue by introducing a second persistent data store in the database, referred to as the outbox table, to store the events to be published to the event streaming platform. A database update is only successful if the event is written to/stored in both the original database table and the output table. A separate entity or process, such as, but not limited to a connector, then reads the events from the output table and publishes or sends the events to a router.

For example, in FIG. 1, the event producer 106 may be configured to output an event when a distributed system 108 (implemented by a set of computers and/or servers operatively or communicably connected) generates or receives an event 111, 112 Specifically, the generating or receiving of an event 111, 112 causes the distributed system 108 to store the event in a database 114 in both a record table 116 and an outbox table 118. An event streaming connector 120 (e.g., a Kafka™ connect JDBC source connector) then extracts events from the outbox table 118 that are relevant to the associated topic (e.g., “Topic A” 110). For example, where the database 114 is an SQL (Structured Query Language) database, the event streaming connector 120 may be configured to periodically execute an SQL query on the outbox table 118 to identify events relevant to an associated topic (e.g., “Topic A” 110); and, create and send an event to the set of one or more event streaming routers 102 for each row in the results. For example, if the topic is a “Rate” topic that is configured store mortgage rate events such as, but not limited to, rate booking events, rate cancellation events and rate processed events, then the event streaming connector for that topic may run an SQL query to identify all of the rate events (e.g., rate booking events, rate cancellation events, and rate processed events etc.) in the outbox table 118 and generate and send an event to the set of one or more event streaming routers 102 for each identified rate event.

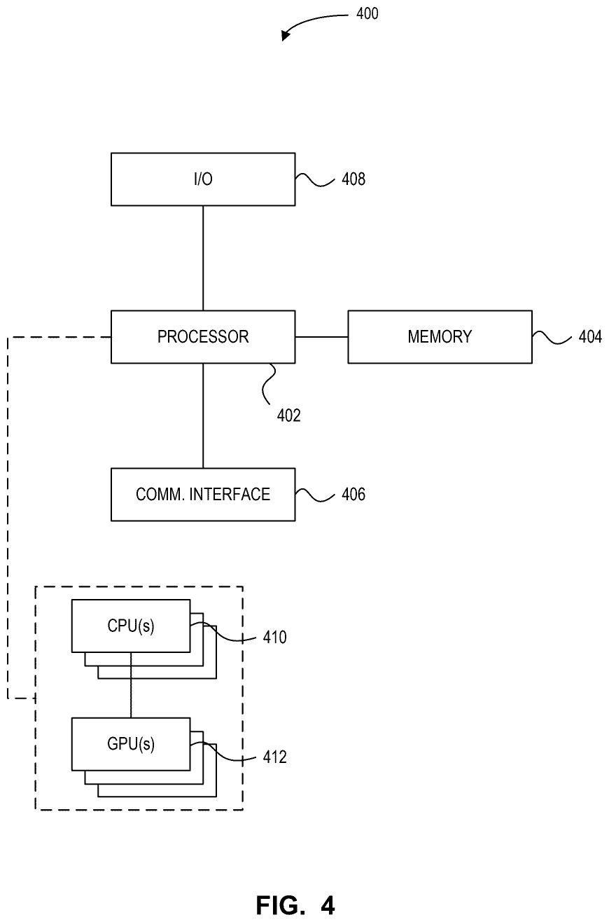

The stream processor system 104 is a computing system comprising one or more computers, such as, but not limited to, the computer 400 of FIG. 4, configured to consume the events in the original topic (e.g., “Topic A” 110), stream those events to the set of one or more event streaming routers 102 for storage in a different, compacted topic 122 and store data (e.g. state data) related to those events in a local store (e.g., state store 124) of the stream processor system 104 in a manner that they can be queried. The stream processor system 104 then periodically (e.g., once a day) analyzes the local store (e.g., state store 124) to determine if one of one or more conditions is satisfied. In response to determining that at least one of the one or more conditions is satisfied, the stream processor system 104 may take one or more actions, such as, but not limited to, creating a new event and sending the new event to the set of one or more event streaming routers 102 for storage in a topic. This allows one event to be used to schedule another, future, event without a separate database. In some cases, the stream processor system 104 is configured to execute computer executable code (e.g., software) which causes the stream processor system 104 to perform the actions described above.

Accordingly, the stream processor system 104 performs stateful event stream processing on the events in a topic (e.g., “Topic A” 110). Stateful event stream processing means that processing can be performed on data from multiple events that arrive at different times. Stateful processing can be contrasted with stateless processing where each event is processed independently. Stateful processing enables more complex and context-aware processing than stateless processing. Specifically, stateful processing enables operations to be performed based on past events. In stateful processing the system maintains a state (e.g., in the local store (e.g., state store 124)) that can be updated and queried. The state can represent any type of information and the specific state information that is stored will depend on the application for which the system 100 is used and the type of events.

For example, where the events relate to mortgages, the state data that may be stored in the local store (e.g., state store 124) of FIG. 1 may comprise a record for each mortgage application (which may be identified by a unique key) that indicates the status of that application and any other relevant information related to the mortgage application.

Some event streaming platforms, such as, but not limited to Apache™ Kafka™, may allow a software engineer to generate, via one or more libraries (e.g., Kafka Streams libraries), software that implements event processors, state stores, and/or punctuators which can interact with the event streaming platform to consume and/or process events. When such an event streaming platform is used in the system 100 of FIG. 1, the stream processor system 104 may comprise an event processor 126, a state store 124, and a punctuator 128. The event processor 126 is a module which can receive and process a stream of events. The event processor 126 uses the state store 124 to record events in a manner that they can be queried. In the examples described herein, the event processor 126 may be configured to (i) consume the events in the original topic (e.g., “Topic A” 110) sequentially; (ii) stream those events to the set of one or more event streaming routers 102 for storage in a different, compacted topic 122; and (iii) update the state store 124 based on those events.

The state store 124 is a structure for storing data related to one or more streams of events. In some cases, the state store 124 may be a key-value store. In such cases, the state store 124 may comprise a record for each unique key and each record can be updated and/or accessed via its unique key. In some cases, the state store 124 may be implemented in a persistent manner (e.g., it may be implemented in non-volatile memory such as, but not limited to, dynamic random access memory (DRAM)) or in a non-persistent manner (e.g., in volatile memory such as, but not limited to, random access memory (RAM)). In some cases, a persistent state store may be implemented as a RocksDB™ data store. In some cases, a non-persistent store may be implemented as a hash table. A non-persistent state store may be referred to as an in-memory state store. In some cases, the state store 124 may be accessible via one or more application programming interfaces (APIs).

In the examples described herein, the state store 124 is configured to store data related to the events in the main topic (e.g., “Topic A” 110) and optionally, one or more other topics. Specifically, the event processor 126 is configured to, for each received event from the main topic (e.g., “Topic A” 110), update the state store 124 based on the event—e.g., update the state store 124 to reflect the event. In some cases, the event processor 126 may be configured to use the state store 124 to log the consumed events such that the state store 124 acts as an event log. Since the state store 124 comprises the events in the compacted topic 122 the state store 124 can be described as a log of the events in the compacted topic 122. In some cases, the state store 124 may comprise a record for each consumed event and updating the state store 124 based on a received event comprises storing a copy of the received event in the state store 124.

In other cases, the event processor 126 may be configured to use the state store 124 to store the current state for each different item or entity referenced in the events in the main topic (e.g., “Topic A” 110). Specifically, as described above, an event generally comprises a key that identifies the event or the entity it pertains to and a value that holds the actual data. In some cases, an event may also comprise other information. Thus, two events that relate to the same entity may comprise the same key. In such cases, the state store 124 may be configured to comprise a record for each unique key and updating the state store 124 based on a received event may comprise updating the record for that key based on the information in the event. If a record does not exist for a key in a received event, then a new record may be created in the state store 124.

For example, where the events relate to mortgage applications and specifically rates for mortgage applications (which may be referred to as rate events), events that relate to the same mortgage application may comprise the same key. The initial rate event for a mortgage application may be a rate booking event indicating that a customer has locked in a mortgage rate for a predetermined period of time. When that initial rate event is consumed/received by the event processor 126, the event processor 126 may be configured to create a new record in the state store 124 for that mortgage application which is associated with the key in the initial rate event. The new record may comprise information regarding the rate for the mortgage such as, but not limited to, the fact that the rate is pending and the date at which the rate is to expire. When subsequent rate events that relate to the same mortgage application are consumed/received by the event processor 126, the event processor 126 may be configured to update the record for that mortgage application to reflect the information in the subsequent event. For example, if a subsequent rate event indicates that the rate has been processed (e.g., the mortgage application has been funded) the event processor 126 may be configured to update the record for that mortgage application to reflect the fact that the rate has been processed and thus is no longer pending. Similarly, if a subsequent rate event indicates that the rate has been cancelled (e.g., the mortgage application or the specific rate offered has been cancelled), the event processor 126 may be configured to update the record for that mortgage application to reflect that the rate has been cancelled and thus is no longer pending.

The punctuator 128 is a module that can perform periodic actions or processing. The punctuator 128 can inspect the state store 124 and perform operations based on the inspection. The punctuator 128 thus provides the ability to schedule arbitrary operations. The punctuator 128 can be scheduled based on stream time or wall clock time. In the examples described herein, the punctuator 128 is configured to periodically (e.g., once a day) review the data in the state store 124 to determine if one or more conditions is satisfied. For example, if the events that are consumed comprise rate booking events that specify an expiry date for a mortgage interest rate, a condition may be satisfied if the punctuator 128 determines, from the state store 124, that there is a pending (e.g., it has not been cancelled or processed) mortgage rate booking that has an expiry date that is a predetermined time (e.g., 10 days) from the current date.

If the punctuator 128 determines that a condition of the one or more conditions is satisfied, then the punctuator 128 may be configured to perform one or more actions. In one example, one of the one or more actions may comprise generating a new event and sending the new event to the set of one or more event streaming routers 102 for storage in the original topic (e.g., “Topic A” 110), or another topic. For example, if, as described above, the punctuator 128 determines, from the state store 124, that a rate for a mortgage application was booked with an expiry date that is a predetermined time (e.g., 10 days) from the current date, the punctuator 128 or the event processor 126 may be configured to generate a reminder or notification event which is sent to the set of one or more event streaming routers 102 for storage in the original topic (e.g., “Topic A” 110) or another topic. This allows a new event to be created or scheduled from a previous real-time event without using a separate database to store the original events.

In some cases, the punctuator 128 may also, upon determining that a condition of the one or more conditions is satisfied, delete the data (e.g., record(s)) associated with the satisfied condition from the state store 124. The associated data (e.g., associated records(s)) can be deleted from the state store 124 since that data has already been processed and will not trigger any further actions.

In some cases, where the stream processor system 104 (e.g., punctuator 128) is configured to generate a new event in response to detecting that one of the one or more conditions is satisfied, the system 100 may further comprise an event consumer (e.g., notification system 130) that is configured to consume the new event. For example, where the new event is a notification event, the event consumer may be a notification system 130 that is configured to, in response to receiving a notification event, send a reminder to, for example, a client via a client device 132. In some cases, the reminder may be sent via email. In other cases, the reminder may be sent in another manner (e.g., via, text, or an instant messaging application).

In some cases, in addition to the punctuator 128 analyzing the records in the state store 124 to determine whether a condition for performing an action (e.g., generating a new event) is satisfied, the punctuator 128 may also be configured to (periodically) prune the data/records in the state store 124 based on one or more pruning conditions. The pruning may be performed to eliminate data and/or records that are not relevant to the action conditions—i.e., they cannot trigger an action (e.g., the generation of a new event). The pruning may help ensure that the state store 124 does not grow indefinitely. For example, if the events that are consumed comprise rate booking events that specify an expiry date for a mortgage interest rate and an action is taken (e.g., a reminder event is issued) if it is determined from the state store 124 that there is a pending (e.g., it has not been cancelled or processed) mortgage rate booking that has an expiry date that is a predetermined time (e.g., 10 days) from the current date, then the punctuator 128 may be configured to periodically (e.g. once a day) delete records in the state store 124 that relate to mortgages that have been cancelled or have been processed because those records will never trigger an action.

In some cases, streaming the events in the original topic (e.g., “Topic A” 110) to the compacted topic 122 enables the state of the local store (e.g., state store 124), to be restored from that compacted topic in failure cases. Specifically, to make the state store 124 fault-tolerant, the state store 124 is backed up by the compacted topic 122. For example, if the state store 124 is an in-memory state store and there is a failure of the device or computer that implements the stream processor system 104, then the contents of the state store 124 may be lost. In such cases, the state store 124 can be fully restored from the compacted topic 122. In contrast to a standard or normal topic in which all events are stored for a predetermined time, in a compacted topic only the latest version of a key's value is kept. In other words, if two events have the same key (indicating that the events are related) then only the value associated with the most recent of those events is kept. Using a compacted topic prevents the topic from growing indefinitely, to reduce the storage requirements for the topic.

In some cases, the set of one or more event streaming routers 102 may also receive other streams of events which are stored in other topics and the events in one or more of those topics may also be consumed by the stream processor system 104. For example, as shown in FIG. 1, the set of one or more event streaming routers 102 may also receive events for a second topic (e.g., “Topic B” 134) and the events in that topic may also be consumed by the stream processor system 104. In such cases, the events in the second topic (e.g., “Topic B” 134) may be triggered by the distributed system 108 generating or receiving an event 136 for that topic and storing the event in both the record table 116 and the outbox table 118 of the database 114. A second event streaming connector 138 associated with the second topic (e.g., “Topic B” 134) may be configured to periodically query (e.g., via an SQL query) the outbox table 118 for events related to the second topic (e.g., “Topic B” 134) and send an event to the set of one or more event streaming routers 102 for storage in the second topic (e.g., “Topic B” 134) for each identified event. Where, for example, the first topic (e.g., “Topic A” 110) is configured to store mortgage rate events, the second topic (e.g., “Topic B” 134) may be configured to store mortgage application events (e.g., events related to a mortgage application).

In some cases, one or more of the other topics (e.g., “Topic B” 134) may be related to the main topic (e.g., “Topic A” 110) such that the stream processor system 104 may be configured to, when it consumes an event in other topic (e.g., “Topic B” 134), determine whether that event is relevant to the events in the main topic (e.g., “Topic A” 110) and, if so, send that event to the compacted topic 122 and update the state store 124 based on that event. For example, where the first topic (e.g., “Topic A” 110) is configured to store mortgage rate events and the second topic (e.g., “Topic B” 134) is configured to store mortgage application events (e.g., events related to a mortgage application), the stream processor system 104 may be configured to, if it determines that an event from the second topic (“Topic B” 134) indicates that a mortgage application has been cancelled, send an event to the compacted topic 122 regarding the cancellation and update the state store 124 to reflect the cancellation so that an action (e.g. a reminder event) is not initiated for that mortgage application.

In some cases, one or more of the event processor 126, punctuator 128 and state store 124 may be implemented by Java™ code. In some cases, the event processor 126, punctuator 128 and state store 124 may be implemented by a single piece of code. In other cases, one or more of the event processor 126, punctuator 128 and state store 124 may be implemented by different pieces of code.

In some cases, the main topic (e.g., “Topic A” 110) may have, in addition to the stream processor system 104, one or more other consumers (e.g., consumer 140) which are configured to process the events in the main topic (e.g., “Topic A” 110) for a purpose other than triggering future actions. In contrast, the compacted topic 122 may only have one consumer—the stream processor system 104.

In some of the examples described herein the event streaming platform is described as being Apache™ Kafka™, but the techniques and principles described herein are not limited to an Apache™ Kafka™ event streaming platform and can be equally applied to other event streaming platforms.

As described above, in some examples the stream processor system 104 may comprise an event processor 126, punctuator 128 and state store 124 wherein the event processor 126 consumes events from a main topic (e.g., “Topic A” 110), streams the consumed events from the main topic (e.g., “Topic A” 110) to the compacted topic 122 and updates the state store 124 based on the consumed events from the main topic (e.g., “Topic A” 110). However, in other examples, the stream processor system 104 may comprise an event processor 126, punctuator 128 and state store 124 wherein the event processor 126 consumes events from a main topic (e.g., “Topic A” 110) and streams the consumed events from the main topic (e.g., “Topic A” 110) to a compacted topic 122. However, instead of the event processor 126 updating the state store 124 based on the consumed events from the main topic (e.g., “Topic A” 110), the event processor 126 or the punctuator 128 may be configured to consume the events in the compacted topic 122 and update the state store 124 based on the consumed events from the compacted topic 122. In either example, the state store 124 has a log of events in the compacted topic 122.

### Example Scenario

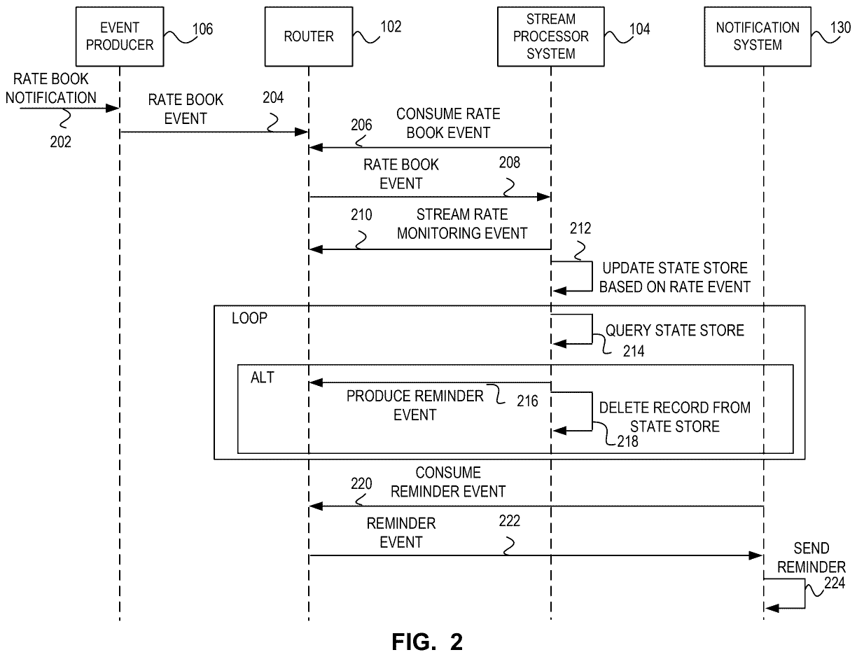

Reference is now made to FIG. 2 which illustrates an example of how the stream processing system 100 described herein may be used to generate a rate reminder 10 days before a mortgage rate expires. The method begins at step 202 where on Jan. 1, 2024, a customer applies for a mortgage and locks in an interest rate of 1.95% that will expire in 120 days (i.e., Apr. 30, 2024) which causes a rate booked event to be received at the event producer 106. This causes, at step 204, the event producer 106 to generate and send a “Rate Booked” event to the set of one or more event streaming routers 102 where it is stored in a “Rate” topic. The event producer 106 may also generate and send other events to the set of one or more event streaming routers 102 which may be stored in the same topic or in one of one or more other topics. At step 206, the stream processor system 104 consumes the “Rate Booked” event which causes, at step 208, the set of one or more event streaming routers 102 to provide the “Rate Booked” event to the stream processor system 104.

In response to receiving the “Rate Booked” event, the stream processor system 104 (i) at step 210, creates a new event, a “Rate Monitoring” event, based on the “Rate Booked” event and streams the new event to the set of one or more event streaming routers 102 for storage in a “Rate Monitoring” compacted topic and, (ii) at step 212, updates the local store (e.g., the local state store 124) based on the new event sent to the compacted topic. For example, the stream processor system 104 may cause a new record to be crated in the local store (e.g., the local state store 124) for the new mortgage application that comprises information identifying the date at which the rate is to expire and optionally other information such as, but not limited to, the rate. Periodically (e.g., every day), the stream processor system 104 (e.g., the punctuator 128 thereof), at step 214, queries the local store (e.g., the local state store 124) to find applications with rates that are to expire in 10 days. On Apr. 30, 2024, the stream processor system 104 finds the application with the rate 1.95% is to expire in 10 days. This causes the stream processor system 104 (e.g., the punctuator 128 thereof) to (i) at step 216, create a new real-time event, a “Reminder” event, and send the new real-time event to the set of one or more event streaming routers 102 for storage in the original topic (e.g., the “Rate” topic) or another topic and (ii), at step 218, delete the record associated with the identified application in the local store (e.g. the local state store 124). The notification system 130 may then, at step 220, consume the “Reminder” event which causes the set of one or more event streaming routers 102 to, at step 222, provide the “Reminder” event to the notification system 130. In response to receiving the “Reminder” event, the notification system 130 may then, at step 224, send a notification to the customer.

### Example Method

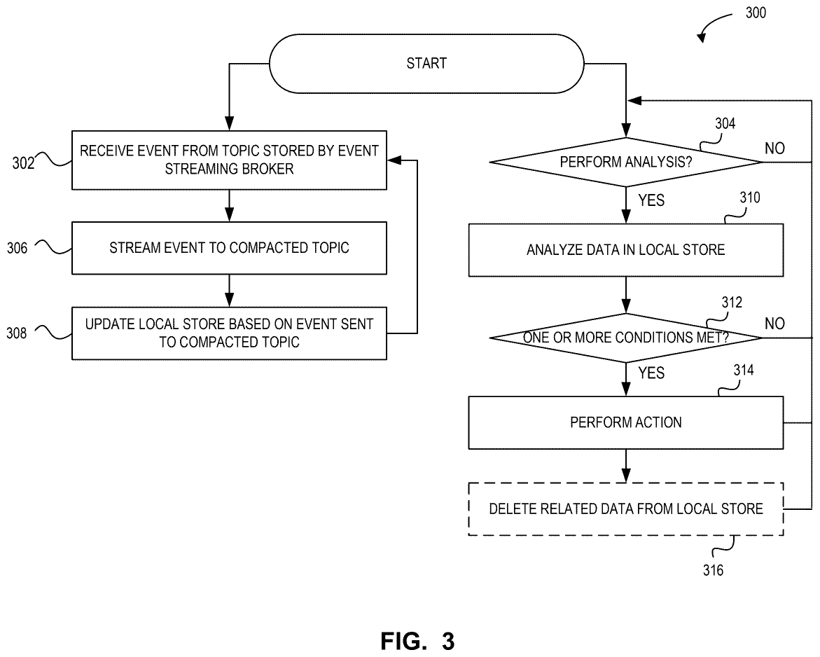

Reference is now made to FIG. 3 which illustrates an example method 300 of stream processing which may be implemented by the system 100 of FIG. 1, and specifically the stream processor system 104 thereof. The method 300 begins at blocks 302 and 304 (e.g., blocks 302 and 304 may be executed in parallel).

Specifically, at block 302 the stream processor system 104 receives (i.e., consumes) an event from a topic (e.g., “Topic A” 110) managed by a set of one or more event streaming routers 102. Once the stream processor system 104 has received the event, the method 300 proceeds to block 306 where the stream processor system 104 streams the received event to the set of one or more event streaming routers 102 for storage in a compacted topic (e.g., compacted topic 122); and block 308 where the stream processor system 104 updates a local store (e.g., local state store 124) based on the event sent to the compacted topic (e.g., compacted topic 122).

As described above, in some cases the stream processor system 104 may be configured to use the local store (e.g., local state store 124) to log the events sent to the compacted topic such that the local store acts as a log of the events in the compacted topic. In some cases, the stream processor system 104 may be configured to store a record in the local store (e.g., local state store 124) for each event sent to the compacted topic. In such cases, updating the local store (e.g., local state store 124) based on the event sent to the compacted topic may comprise creating a new record in the local store (e.g., local state store 124) for the event. In other cases, the stream processor system 104 may be configured to keep a record for each different entity or object referenced in the events sent to the compacted topic that indicates the status of the entity or object. In such cases, updating the local store (e.g., local state store 124) based on the event sent to the compacted topic may comprise updating the record for the entity or object referenced in the event with the status of that entity or object as indicated in the event. Where a record does not exist for an entity or object referenced in the event then updating the local store (e.g., local state store 124) based on the event may comprise creating a record for the entity or object referenced in the event.

Once the received event has been streamed to the compacted topic (block 306) and the local store has been updated based thereon (block 308), the method 300 proceeds back to block 302 where the stream processor system 104 waits for the next event from the topic (e.g., “Topic A” 110). Once the next event from the topic (e.g., “Topic A” 110) has been received, the stream processor system 104 repeats blocks 306 and 308 for that event.

At block 304, the stream processor system 104 determines whether the one or more conditions for performing an analysis on the data in the local store (e.g., local state store 124) are met. For example, in some cases, the stream processor system 104 may be configured to perform an analysis of the data in the local store (e.g., local state store 124) at a scheduled time each day. In such cases, the stream processor system 104 may be configured to determine that the conditions for performing an analysis on the data in the local store (e.g., local state store 124) are met if it is the scheduled time of day. This is just an example of a set of conditions for performing an analysis on the data in the local store (e.g., local state store 124) and other conditions for performing an analysis on the data in the local store (e.g., local state store 124) may be used. If it is determined that the conditions for performing an analysis on the data in the local store (e.g., local state store 124) are met, then the method proceeds to block 310.

At block 310, the stream processor system 104 analyzes the data in the local store (e.g., local state store 124) to determine if at least one condition of the one or more conditions is met for performing an action. The one or more conditions which are used to determine whether an action is to be performed are based on the type of events which are logged in the local store (e.g., local state store 124) and the compacted topic, and the application in which the events are used. For example, as described above, if the events that are consumed comprise rate booking events that specify an expiry date for a mortgage interest rate, a condition may be satisfied if the stream processor system (e.g. punctuator 128) determines, from the state store 124, that there is a pending (e.g., it has not been cancelled or processed) mortgage rate booking that has an expiry date that is a predetermined time (e.g., 10 days) from the current date. In this manner the events in the topic are both processed by the stream processor system 104 in real time and at a later time without the use of a database.

At block 312, it is determined from the analysis performed in block 310, whether at least one condition of the one or more conditions for performing an action is met. If it is determined that none of the one or more conditions for performing an action is met, then the method 300 proceeds back to block 304 where the stream processor system 104 waits until the conditions for performing the next analysis of the data in the local store (e.g., local state store 124) are met. If, however, it is determined that a least one condition of the one or more conditions for performing an action is met, then the method 300 may proceed to block 314 where at least one action is taken. Specifically, an action may be taken for each event or set of events (e.g., the set of events related to the same entity or object) that meets at least one condition for performing an action. For example, if there is more than one pending mortgage rate booking that has an expiry date that is the predetermined time (e.g., 10 days) from the current date, then an action may be taken for each such mortgage rate booking.

As described above, in some cases, the action that is taken in response to a condition for taking action being met may comprise generating a new event and sending the new event to the set of one or more event streaming routers 102 for storage in the topic (e.g., “Topic A” 110) or another topic. The event may then be processed by a consumer of that topic. For example, as described above, in the mortgage rate booking example, when a pending mortgage rate booking with a deadline that is 10 days from the current date is identified, a notification event may be created and sent to the set of one or more event streaming routers 102 where it is stored in a topic. A notification system 130 may then consumes the notification event which causes the notification system 130 to send a reminder to the client/customer (e.g., via a client device 132).

Once the at least one action has been taken, the method 300 may end or the method 300 may proceed to block 316 where the data related to the at least one action is deleted or removed from the local store (e.g., local state store 124). For example, in some cases, only one action may be performed for an event (or set of related events) so once an action has been performed for the event (or set of related events—e.g., events with the same key) the data related to that event (or set of related events—e.g., events with the same key) can be removed from the local store (e.g., local state store 124). For example, in the mortgage rate booking example described herein, it may be desirable to send only one reminder—e.g., at 10 days before the deadline. In such cases, once a pending mortgage rate booking has been identified with a deadline that is 10 days from the current date and an action is taken (e.g., a notification event is created and sent to the set of one or more event streaming routers 102) then the data related to that mortgage rate booking may be deleted or removed from the local store (e.g., local state store 124). Deleting data in the local store that is no longer needed can help manage the size of the local store (e.g., local state store 124).

As described above, in some cases, the stream processor system 104 may also be configured to periodically (e.g., once a day) prune the data in the state store 124 to remove data that may no longer trigger an action. The data that is to be pruned may be specified by one or more pruning conditions. For example, in the mortgage rate booking example, the stream processor system 104 may be configured to identify and delete data in the local store (e.g., local state store 124) that relates to a mortgage rate booking that has been cancelled or has been processed. In such cases, the method 300 may further comprise periodically pruning the records in the local store (e.g., local state store 124) based on one or more pruning conditions.

In some cases, blocks 302, 306 and 308 of the method 300 of FIG. 3 may be implemented by an event processor (e.g. event processor 126) of the stream processor system 104 and blocks 304, 310, 312, 314, 316 of the method 300 of FIG. 3 may be performed by a punctuator 128 of the stream processor system 104. However, this is an example only, and the blocks of the method 300 of FIG. 3 may be divided between the components of the stream processor system 104 in another manner.

FIG. 3 illustrates an example order of the blocks of the method 300 and in other examples, the blocks may be executed in a different order.

### Example Computer

Reference is now made to FIG. 4 which illustrates a simplified block diagram of an example computer 400. Computer 400 is an example implementation of a computer which may implement all or a part of the system 100 of FIG. 1 and/or all or a part of the method 300 of FIG. 3. For example, computer 400 may implemented all or a part of the set of one or more event streaming routers 102, the stream processor system 104 and/or the event producer 106. Computer 400 has at least one processor 402 operatively coupled to at least one memory 404, at least one communications interface 406 (also referred to herein as a network interface), and at least one input/output (I/O) device 408.

The at least one memory 404 includes a volatile memory that stores instructions executed or executable by the processor 402, and input and output data used or generated during execution of the instructions. The memory 404 may also include non-volatile memory used to store input and/or output data—e.g., within a database—along with program code containing executable instructions.

The processor 402 may transmit or receive data via the communications interface 406 and may also transmit or receive data via any additional input/output device 408 as appropriate.

In some cases, the processor 402 may include a system of central processing units (CPUs) 410. In other cases, the processor 402 includes a system of one or more CPUs 410 and one or more Graphical Processing Units (GPUs) 412 that are coupled together.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A distributed event data store system comprising:
a stream processor system comprising a memory, a communication interface and at least one processor operatively coupled to the memory and the communication interface, the stream processor system configured to:
consume, in real-time, a stream of events stored in a topic by a set of one or more event streaming routers;
stream the consumed events to the set of one or more event streaming routers for storage in a compacted topic;
update data in a local store of the stream processor system based on the events in the compacted topic;
periodically query the local store to determine if one or more conditions is met; and
in response to determining that at least one of the one or more conditions is met, take an action.

2. The system of claim 1, wherein taking an action comprises generating a new event and providing the new event to the set of one or more event streaming routers for storage in the topic or a different topic.

3. The system of claim 2, wherein the new event is a notification event, and the distributed event data store system further comprises a notification system configured to consume the notification event.

4. The system of claim 3, wherein the notification system is configured to, in response to consuming the notification event, send a notification to an end-user.

5. The system of claim 1, wherein the stream processor system comprises a punctuator and the punctuator is configured to periodically query the local store to determine if the one or more conditions is met.

6. The system of claim 1, wherein the stream processor system comprises an event processor and the event processor is configured to consume the stream of events in the topic and stream the consumed events to the set of one or more event streaming routers for storage in the compacted topic.

7. The system of claim 1, wherein the local store is a state store.

8. The system of claim 7, wherein each event of the stream of events stored in the topic comprises a key that identifies an entity that the event pertains to, and updating the data in the local store of the stream processor system based on the events in the compacted topic comprises maintaining, in the local store, a record for each unique key that identifies a state of the corresponding entity.

9. The system of claim 1, wherein an event of the stream of events stored in the topic has an end date associated therewith and a condition of the one or more conditions is met if a current date is a predetermined period from the end date associated with the event.

10. The system of claim 1, wherein the stream processor system is further configured to, in response to determining that at least one of the one or more conditions is met, remove data from the local store associated with the at least one condition.

11. The system of claim 1, wherein the stream processor system is further configured to periodically prune the data in the local store based on one or more pruning conditions.

12. The system of claim 1, further comprising the set of one or more event streaming routers configured to: receive the stream of events from an event producer node and store the received events in the topic; and receive the consumed events and store the consumed events in the compacted topic.

13. A method of stream processing, the method executed in a computing environment comprising a stream processor system comprising at least one processor, a communication interface, and memory, and the method comprising:
consuming, in real-time, a stream of events stored in a topic by a set of one or more event streaming routers;
streaming the consumed events to the set of one or more event streaming routers for storage in a compacted topic;
updating data in a local store of the stream processor system based on the events in the compacted topic;
periodically querying the local store to determine if one or more conditions is met; and
in response to determining that at least one condition of the one or more conditions is met, taking an action.

14. The method of claim 13, wherein taking an action comprises generating a new event and providing the new event to the set of one or more event streaming routers for storage in the topic or a different topic.

15. The method of claim 13, wherein the local store is a state store.

16. The method of claim 15, wherein each event of the stream of events stored in the topic comprises a key that identifies an entity that the event pertains to, and updating the data in the local store of the stream processor system based on the events in the compacted topic comprises maintaining in the local store a record for each unique key that identifies a state of the corresponding entity.

17. The method of claim 13, wherein an event of the stream of events stored in the topic has an end date associated therewith and a condition of the one or more conditions is met if a current date is a predetermined period from the end date associated with the event.

18. The method of claim 13, further comprising, in response to determining that at least one of the one or more conditions is met, removing data from the local store associated with the at least one condition.

19. The method of claim 13, further comprising, periodically pruning the data in the local store based on one or more pruning conditions.

20. A non-transitory computer readable medium storing computer executable instructions which, when executed by at least one computer processor, cause the at least one computer processor to carry out a method for stream processing, the method comprising:
consuming, in real-time, a stream of events stored in a topic by a set of one or more event streaming routers;
streaming the consumed events to the set of one or more event streaming routers for storage in a compacted topic;
updating data in a local store based on the events in the compacted topic;
periodically querying the local store to determine if one or more conditions is met; and
in response to determining that at least one condition of the one or more conditions is met, taking an action.
